(19) United States
(12) Patent Application Publication
(10) Pub. No.: US 2006/0183388 A1
(43) Pub. Date: Aug. 17, 2006

(54) Coloured polypropylene/polystyrene support

(76) Inventor: Mohammed Ali Ali Hassan, Cairo (EG)

Correspondence Address: HOVEY WILLIAMS LLP, 2405 GRAND BLVD., SUITE 400, KANSAS CITY, MO, 64108, US

(21) Appl. No.: 11/346,724

(22) Filed: Feb. 3, 2006

Related U.S. Application Data
(63) Continuation-in-part of application No. PCT/IB05/00035, filed on Jan. 11, 2005.

(30) Foreign Application Priority Data
Oct. 3, 2004 (EG) EG424/10/2004
Nov. 10, 2004 (EP) 04447245

(51) Int. Cl. B32B 27/00; B32B 27/32; B32B 5/02

(52) U.S. Cl. 442/59; 428/500; 428/523; 428/402

(57) ABSTRACT

Colouring process of Polypropylene/polystyrene support, in which the support is coloured by means of an aqueous composition comprising from 0.1 to 4% by weight disperse dye, organic acid with 1 to 6 carbon atoms, and at least a surfactant, whereby said colouring is operated partly at a temperature higher than 90° C.

This application is a continuation in part of PCT/IB2005/000035 filed on 11 Jan. 2005 and claiming the priority of European Patent Application 04447245.4 filed on Nov. 10, 2004, as well as of Egyptian patent application EG424/10/2004 filed on Oct. 3, 2004, the disclosures of which are incorporated herein by reference.

### FIELD OF THE INVENTION

The invention relates to the colouring (dying, printing) of polypropylene/polystyrene supports, such as fibres, films, moulded products, etc. and especially to the dyeing and/or printing of carpets (such as tufted carpets, woven carpets, non woven carpets, etc.), fabrics, etc. made at least partly of polypropylene/polystyrene fibres or threads and/or the printing of films.

### THE PRIOR ART

Polypropylene is well-known to be a material difficult to be printed and/or dyed.

It is well known that the dying of polypropylene fibres by using common dying technique is difficult and that no correct dyed polypropylene fibres can be achieved.

Therefore the most common method for preparing coloured polypropylene fibres is to include solid pigment in the polypropylene composition before its spinning.

In order to solve said problem, it is known to add some amide derivatives (polyesteramides, polyetheramides, copolyamide) to the polypropylene composition. Such additives are disclosed in U.S. Pat. No. 6,679,754.

Polypropylene/polystyrene fibres are disclosed in U.S. Pat. No. 6,248,835. However, said patent is silent about the dyeability of the fibres, and most especially to the dying of the fibres.

U.S. Pat. No. 6,248,835 discloses a polymer blend of PP and amorphous PS. No reference is made in said document to the dying of fibres, nor to the presence of organic acid in the dying composition or in the fibres.

GB 1,372,173 relates to a carpet and to the problem of dyeing synthetic polymers. In said document, a blend of polyolefins with styrene copolymers, such as ABS is considered as having good dye absorption. ABS is considered as being the best styrene copolymer. From example 11 of said document, it appears that the dying is function of the structure styrene-butadiene copolymer, the ABS having the most appropriate structure. No reference is made in said document to the used of syndiotactic PS or atatic polystyrene.

In the dying operation, no reference is made to the use of organic acid for achieving a good dying.

GB 1,317,557 discloses the preparation of coloured synthetic fibres from a fibrillated film. As stated in said document, it is well known that it is very difficult to obtain dyed polyolefin, especially polyethylene and polypropylene, in which the dyestuff is wholly compatible with the polymer and hence when such dyed polyolefins are extruded through narrow orifices in a profiled die there is a strong Tendency for the dyestuff to extrude out from the main polymer mass and so clog the narrow orifice.

According to a process proposed by said document for solving this problem, polypropylene is blended with a homopolymer, a copolymer or an interpolymer of styrene and with a dyestuff. The blend is extruded into a profiled web having a plurality of grooves.

In all the examples of said document, tests have been made by using a blend of 74% by weight propylene homopolymer and 26% by weight of an interpolymerized polystyrene containing 5-10% of a butadiene-based synthetic elastomer. In some example, the dyeing has been operated by means of an dyeing aqueous bath. From example VII of said document, it appears that the dyeability of the polypropylene blend depends from the used copolymer. According to said example, the best dyeability is achieved ABS. No reference is made to the use of atactic or syndiotactic polystyrene.

It has now been discovered that polypropylene supports could easily be printed and dyed by using known dying and printing methods by adding some atactic and/or syndiotactic polystyrene (homopolymer) to the polypropylene. As used herein, “polypropylene/polystyrene supports” or the abbreviation “PP/PS supports” is to be understood as supports e.g. a fibre filling, yarn or thread, comprised of polypropylene to which a quantity of polystyrene is added. It has among others been discovered that polypropylene fibres had an excellent dyeability when some of said polystyrene was added and when the dying was operated in presence of at least some acid(s) and at least carried out partly at temperature higher than 90° C., especially higher than 130° C. and under pressure.

It has further been discovered that the printed or dyed PP/PS support was more soft than a common PP support, whereby increasing the touch character of the support, fibres or threads.

It has further been discovered that such dyed PP/PS fibre or thread enables a better recovering of their initial shape or position.

The invention will now further be disclosed.

### DESCRIPTION OF THE INVENTION

The invention relates to a colouring process of Polypropylene/polystyrene support, especially fibres, films, etc. (such as a dying process or a printing process), in which the support (fibres, film, etc.) is coloured (dyed or printed with one or more dyes) by means of an aqueous composition comprising from 0.1 to 4% by weight disperse dye, organic acid with 1 to 6 carbon atoms, and at least a surfactant, whereby said colouring is at least operated partly at a temperature higher than 90° C. When dyeing, the colouring step is advantageously carried out at least partly at a temperature higher than 130° C. and under pressure higher than 10⁵ Pa.

The polystyrene is selected from the group consisting of syndiotactic polystyrenes (homo polystyrene) , atactic polystyrenes (homo polystyrene) or mixtures thereof. When using a mixture of such polystyrene, the weight ratio atactic polystyrene/syndiotactic polystyrene is for example comprised between 1:99 and 99: 1, advantageously between 1:50 and 50: 1, preferably between 1:20 and 20:1. Syndiotactic polystyrenes are preferred. When using a blend of polystyrene, the blend is advantageously rich in syndiotactic polystyrene, i.e. more than 50% syndiotactic polystyrene.

Advantageously the PP/PS support is substantially free of PS other than syndiotactic PS and atactic PS. For example, with respect to the total weight of PS, less than 5% (preferably less than 2%, most preferably less than 1%) of PS is constituted by PS other than syndiotactic PS and atactic PS.

It has been observed that best colouring (dying, printing) of the support was achieved when the polypropylene/polystyrene support (fibres, film, etc.) has a polystyrene/polypropylene weight ratio comprised between 1:10 and 1:5. When using polypropylene support (fibres, films, etc.) with a weight ratio polystyrene/polypropylene comprised between 13:87 and 17:83 (most preferably about 15:85), the colouring (dying, printing) ability or suitability of the support (such as fibres, films, etc.) was quite constant, meaning an easy control of the dying process.

Advantageously, the organic acid with 1 to 6 carbon atoms is present in the composition, so that the pH is comprised between 3 and 5, preferably about 4.

The organic acid is preferably citric acid. Advantageously, only citric acid is used as organic acid.

According to an embodiment, the pH of the colouring (dying, printing) composition is maintained at a substantially constant pH by addition of acid during the dying process.

Preferably, at least citric acid is used as organic acid.

Most preferably, the organic acid content of the composition is comprised between 1 and 10 g/l, preferably between 1 and 5 g/l.

According to a detail of preferred embodiments, the colouring (dying, printing) is at least operated at a temperature higher than 130° C. during at least 5 minutes, advantageously at least 10 minutes, preferably at least 15 minutes. For example the temperature is comprised between 130° C. and 170° C., such as from 140° C. to 150° C., during at least 5 minutes, advantageously at least 10 minutes, preferably 15 minutes.

The support (such as fibres, films, etc.) can comprise one or more other additives. However, advantageously, the support (fibres, films, etc.) comprises more than 90% by weight polypropylene and polystyrene, preferably more than 95% by weight, more preferably more than 99% by weight.

According to specific embodiment, the dying is operated at least partly at a temperature comprised between 140° C. and 150° C. and/or (preferably and) at least partly at a pressure comprised between 1.5 10⁵ Pa and 10 10⁵ Pa.

After being coloured (dyed or printed), the support (fibres, films, etc.) are advantageously washed and dried. When printed, the support (fibres, threads, films, etc.) is advantageously submitted to a fixing step after being coloured or printed, said fixing step being carried out advantageously during a time comprised between 5 and 40 minutes, preferably between 10 and 25 minutes. Said fixing step is advantageously carried out at a temperature higher than 80° C., preferably greater than 110° C., such as a temperature comprised between 80° C. and 130° C., preferably comprised between 110° C. and 130° C.

Preferably, the fibres form threads, whereby the threads are coloured (dyed or printed).

The invention relates also to:
a coloured (dyed or printed) polypropylene/polystyrene support, especially fibres or threads or films prepared at least partly by a process of the invention as disclosed here above in the present specification,
a product comprising at least coloured (dyed or printed) polypropylene/polystyrene support (such as fibres, threads, films, etc. and combinations thereof) of the invention, said product being advantageously selected from the group consisting of woven fabrics, non woven fabrics, carpets (such as tufted carpets, woven carpets, non woven carpets, etc. and combinations thereof), garments, filter media, furniture upholstery, synthetic paper, films, moulded articles, packaging material and combinations thereof, and
a polypropylene/polystyrene support comprising a matrix made essentially of Polypropylene and Polystyrene, whereby the weight ratio polystyrene/polypropylene is comprised between 1:10 and 1:5, preferably between 12:88 and 17:83, especially about 15:85, whereby said support comprises advantageously from 0.05% and 1% by weight of at least an organic acid with 1 to 6 carbon atoms, preferably citric acid, said matrix comprising advantageously at least 85% by weight, preferably at least 90% by weight (such as 95% by weight or even more, advantageously more than 99%) of polypropylene and polystyrene.

The polypropylene used in the fibres, threads, films or other supports of the invention or used in the coloured process of the invention can be a homo polypropylene or a copolymers, a copolymer of polypropylene with polyethylene, such as with HDPE (high density polyethylene, LLDPE linear low density polyethylene, random and impact copolymers. The polypropylene can be prepared by radical polymerization, catalytic polymerization. Possibly the polypropylene can be mixed with some other polymers than polystyrene, such as polyethylene (High density PE, Low density PE, Medium Density PE). The content of other polymers than polystyrene in the polypropylene can be up to 15% by weight. However the content of other polymers is preferably lower than the polystyrene content thereof. According to a more preferred embodiment, at least 95% by weight, preferably at least 97% by weight of the polymers present in the support are PP and PS

The polypropylene/polystyrene fibres, threads, and other supports of the invention or used in a method of the invention can comprises one or more additives, such as UV absorbers, stabilizers, antioxidants, processing aids, metal deactivators, phosphites, phosphonites, hydroxylamines, nitrones, amine oxides, benzofuranones, indolinones, thiosynergists, peroxide scavengers, co stabilizers, nucleating agents, fillers, reinforcing agents, dispersing agents, lubricants, cross-linking agents, flame proofing agents, antistatic agents, catalysts, rheology additives, flow-control agents, gums, dyes, powder dyes, etc. Examples of such additives are given in U.S. Pat. No. 6,679,754.

The invention relates also to a coloured polypropylene/polystyrene support with a polystyrene/polypropylene weight ratio comprised between 1:10 and 1:5, in which the polystyrene is selected from the group consisting of syndiotactic polystyrene, atatic polystyrene and mixtures thereof, said support having been submitted to a colouring step by contacting the support with an aqueous dying composition having a pH comprised between 3 and 5, said aqueous dying composition comprising from 0.1 to 4% by weight disperse dye, organic acid with 1 to 6 carbon atoms, and at least a surfactant, whereby said colouring step is at least operated partly at a temperature higher than 90° C.

Advantageously, the polypropylene is an amorphous polypropylene.

Preferably, the polypropylene is an amorphous polypropylene having a Tg of about 0° C.

For example, the support is selected from the group consisting of fibres, threads, layers, films and combinations thereof.

According to further examples, the coloured support is selected from the group consisting of woven fabrics, non woven fabrics, carpets, garments, filter media, furniture upholstery, synthetic paper, films, bags, laminated products and combinations thereof.

Preferably, the coloured support comprises a matrix made essentially of Polypropylene and Polystyrene, whereby the weight ratio polystyrene/polypropylene is comprised between 12:88 and 17:83, most preferably about 15:85.

According to an advantageous detail, the coloured support comprises from 0.05% and 1% by weight of at least an organic acid with 1 to 6 carbon atoms. Most preferably, the coloured support comprises from 0.05% and 1% by weight of citric acid.

The coloured support comprises advantageously more than 90% by weight polypropylene and polystyrene, preferably more than 95% by weight polypropylene and polystyrene, most preferably more than about 99% by weight polypropylene and polystyrene.

According to a preferred embodiment, the coloured support has the form of yarns having a breaking load measured according to the norm ASTM D 2256-02 comprised between 3 and 3.15, a breaking tenacity RKm measured according to the norm ASTM D 2256-02 comprised between 2.5 and 3 g/den, and a coefficient of friction measured according to the norm B.S. 3/49 comprised between 0.3 and 0.35.

Advantageously, the coloured yarns have recovery properties such that a woven carpet made of yarns with a weight comprised between 2000 and 3000 denier and with a pileheight of 10 mm compressed to a height of 5 mm by using a constant load of 2.9 kg/m² recovers more than 60% of its pileheight after 2 minutes, advantageously more than 80% of its pileheight after 24 hours, preferably about 100% of its pileheight in less than 48 hours.

The invention further relates to a coloured product selected from the group consisting of carpets and tufted product, whereby said product comprises coloured polypropylene/polystyrene yarns with a polystyrene/polypropylene weight ratio comprised between 1:10 and 1:5, in which the polystyrene is selected from the group consisting of syndiotactic polystyrene, atatic polystyrene and mixtures thereof, said yarns having been submitted to a colouring step by contacting the support with an aqueous dying composition having a pH comprised between 3 and 5, said aqueous dying composition comprising from 0.1 to 4% by weight disperse dye, organic acid with 1 to 6 carbon atoms, and at least a surfactant, whereby said colouring step is at least operated partly at a temperature higher than 90° C.

The polypropylene of said coloured PP/PS yarns is advantageously an amorphous polypropylene.

Preferably, the polypropylene of said coloured PP/PS yarns is an amorphous polypropylene having a Tg of about 0° C.

According to a preferred embodiment, said coloured PP/PS yarns comprises a matrix made essentially of Polypropylene and Polystyrene, whereby the weight ratio polystyrene/polypropylene is comprised between 12:88 and 17:83, preferably about 15:85.

Preferably, said coloured PP/PS yarns comprises from 0.05% and 1% by weight of at least an organic acid with 1 to 6 carbon atoms. Said organic acid is preferably citric acid.

According to advantageous embodiment of the coloured product, said coloured PP/PS yarns comprises more than 90% by weight polypropylene and polystyrene, preferably more than 95% by weight polypropylene and polystyrene, most preferably more than 99% by weight polypropylene and polystyrene.

According to a preferred embodiment of the coloured product, said coloured PP/PS yarns have a breaking load measured according to the norm ASTM D 2256-02 comprised between 3 and 3.15, a breaking tenacity RKm measured according to the norm ASTM D 2256-02 comprised between 2.5 and 3 g/den, and a coefficient of friction measured according to the norm B.S. 3/49 comprised between 0.3 and 0.35. Preferably, the coloured product has recovery properties such that a product made of said coloured PP/PS yarns with a weight comprised between 2000 and 3000 denier and with a pile height of 10 mm compressed to a height of 5 mm by using a constant load of 2.9 kg/m² recovers more than 60% of its pile height after 2 minutes, advantageously more than 80% of its pile height after 24 hours, preferably about 100% of its pile height in less than 48 hours.

The invention relates also to a polypropylene/polystyrene particles intended to be used for the preparation of a support suitable to be processed in a process according to the invention, said particles being characterized in that each particles comprises polystyrene and polypropylene, preferably in the form of a blend of polystyrene and polypropylene.

Advantageously, the particles has an average particle size comprised between 10 μm and 10 mm, advantageously between 100 μm and 5 mm. The particles have advantageously the form of flakes, beads or granules.

Preferably, the particles are characterized by a polystyrene/polypropylene weight ratio comprised between 1:20 and 1:4, preferably between 1:10 and 1:5.

For example, the weight ratio polystyrene/polypropylene is comprised between 1:10 and 1:5, preferably between 12:88 and 17:83, especially about 15:85.

Preferably, the particles have a substantially homogeneous composition.

The particles comprises advantageously one or more additives and/or fillers, such as UV absorbers, stabilizers, antioxidants, processing aids, metal deactivators, phosphites, phosphonites, hydroxylamines, nitrones, amine oxides, benzofuranones, indolinones, thiosynergists, peroxide scavengers, co stabilizers, nucleating agents, fillers, reinforcing agents, dispersing agents, lubricants, cross-linking agents, flame proofing agents, antistatic agents, catalysts, rheology additives, flow-control agents, gums, dyes, powder dyes, etc. Examples of such additives are given in U.S. Pat. No. 6,679,754, the disclosure of which is incorporated herein by reference.

According to a preferred embodiment, the particles consist of a substantially homogeneous matrix.

The polypropylene present in the particles is advantageously an amorphous polypropylene, said amorphous polypropylene having preferably a Tg of about 0° C.

According to an advantageous detail, the particles comprise a matrix made essentially of Polypropylene and Polystyrene, whereby the weight ratio polystyrene/polypropylene is comprised between 12:88 and 17:83, preferably about 15:85.

Advantageously, the particles comprise from 0.05% and 1% by weight of at least an organic acid with 1 to 6 carbon atoms, which is preferably citric acid.

According to a preferred embodiment, the particles comprises more than 90% by weight polypropylene and polystyrene, preferably more than 95% by weight polypropylene and polystyrene, most preferably more than about 99% by weight polypropylene and polystyrene.

### BRIEF DESCRIPTION OF THE DRAWING

FIG. 1 is a pictorial view of a carpet or other tufted product having a multiplicity of supports such as threads or yarns made of polypropylene/polystyrene in accordance with the present invention.

### DESCRIPTION OF THE PREFERRED EMBODIMENTS

### EXAMPLES

Preparation of Polypropylene (PP)/Polystyrene (PS) Fibres

Commercially polypropylene for fiber application has been mixed with polystyrene and with an UV stabiliser. The mixture is fed into an extrusion spinning facility and processed into continuous threads.

The polypropylene used has a Melt Flow rate (MFR ASTM—1238 L) lower than 80 g/10 minutes, preferably lower than 30 g/10 minutes. While the density (ASTM—D1505) of the PP can vary from 0.90 and 0.91 (g/cm³). The melting point of said polypropylene was about 165° C. (DSC). Other properties of the polypropylene are elongation of about 30 to 40%, tenacity of 3 to 5 g/denier, linear skein shrinkage (ASTM D3218) of about 3 to 4.5%, a softening point from about 150° C. and 220° C. (ASTM D-1525). The Polypropylene is advantageously amorphous. The used polypropylene has advantageously a Tg of about 0° C.

The following PP have been used in the preparation of PP/PS fibres.

| | PP1 | PP2 | PP3 | PP4 |
|---|---|---|---|---|
| MFR | 10 | 12 | 27 | 20 |
| g/10minutes | | | | |
| Density | 0.906 | 0.905 | 0.903 | 0.904 |
| g/cm³ | | | | |

The Polystyrene used in the preparation of the PP/PS fibres has the following properties: Melt flow rate (ASTM D-1238 from 1 to 30 g/min, preferably substantially equal to the MFR of the PP to which the polystyrene is added); a Vicat softening point comprised between 160° C. and 220° C. (ASTM D-1525), a tensile strength comprised between 40 and 70 Mpa (ASTM D-638), crystal atactic or syndiotactic (advantageously syndiotactic), density from 1.01 to 1.06 (ASTM D 792). The used polystyrene has advantageously a Tg of about 100° C.

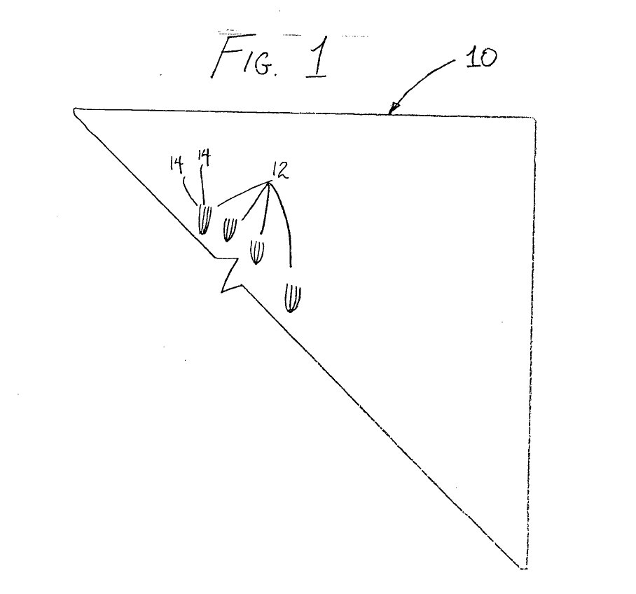

FIG. 1 shows a carpet 10 or other product made from supports 12 such as yarns or threads having fibres 14 of PS/PB in accordance with the present invention.

The following mixtures have been used for preparing the fibres and the threads to be coloured. In said mixtures, the UV stabilizer used was the product Tanvin®.

| | | | UV |
|---|---|---|---|
| | PP | PS | stabilizer |
| Mixture | % by weight | % by weight | % by weight |
| 1 | PP1 90% | PS atactic 9% | 1% |
| 2 | PP2 85% | PS atactic 14.5% | 0.5% |
| 3 | PP2 87% | PS syndiotactic | 0.5% |
| | | 12.5% | |
| 4 | PP3 92.5% | PS atactic 7% | 0.5% |
| 5 | PP3 89.5% | PS atactic 10% | 0.5% |
| 6 | PP3 86.5% | PS atactic 13% | 0.5% |
| 7 | PP3 89.5% | PS syndiotactic | 0.5% |
| | | 10% | |
| 8 | PP3 86.5% | PS syndiotactic | 0.5% |
| | | 13% | |
| 9 | PP4 90% | PS atactic 9% | 1% |
| 10 | PP4 87% | PS atactic 12.5% | 0.5% |
| 11 | PP3 50% + PP2 | PS atactic 12.5% | 0.5% |
| | 37% | | |
| 12 | PP3 87% | PS atactic 6% + PS | 0.5% |
| | | syndiotactic | |
| | | 6.5% | |
| 13 | PP3 87% | PS atactic 10% + PS | 0.5% |
| | | syndiotactic | |
| | | 2.5% | |
| 14 | PP3 87% | PS atactic 2.5% + PS | |
| | | syndiotactic | |
| | | 10% | |
| 15 | PP1 45% + PP2 | PS atactic 9.5% | 0.5% |
| | 45% | | |

The Tg of the so prepared blend was lower than 100° C., but greater than 0° C. It was observed that the addition of polystyrene to the polypropylene decreased the crystallinity of the polypropylene and increased the hygrogroscopicity or the property to absorb water moisture with respect to polypropylene alone.

The fibres and threads are produced according to known techniques, such as extrusion spinning fixture. The fibres and threads can thereafter be coloured or printed, possibly after a post process step, such as a step for producing a fabric, woven fabric, a non woven fabric, carpet (tufted carpet, woven carpet, non woven carpet, combinations thereof), loop and cut pile carpets, floor covering, yarns, textile, artificial leather, etc.

Colouring Step

Threads prepared from the mixtures 1 to 15 have been coloured according to the following processing.

Stage 1

The threads are winded on a metal perforated support, such as cones. The threads have been prewashed at 70° C. in an aqueous bath with a soap, back washed and rinsed.

Stage 2

A dyeing bath has been prepared as follows: water has been mixed with a levelling agent (anionic/non ionic), a dispersant, a lubricant and citric acid. A dispersion dye suitable for polyester is added and mixed to the bath. Said mixing is advantageously made at a temperature of about 50° C.

The dyeing bath had a pH of about 4, a disperse dye content comprised between 2 and 4%, a levelling agent or leveller content of about 1 g/l, a dispersant agent of about 1 g/l, a lubricant content of about 1 g/l. The citric acid content is of at least 0.5 g/l and is adjusted so as to achieve the desired pH, such as about 3.5 or about 4 during the whole dying operation. Levelling agent or leveller, dispersant are well known for disperse dyes. The agitation of the bath has been maintained during at least 15 minutes, preferably from 20 to 40 minutes.

Examples of disperse dyes used for colouring the fibres or threads are: Introsol disperse dyes, such as Introsol Red 73 GL 200%, Introsol Yellow 4G, Introsol Blue 73 BG 200%, Trasil Navy Blue GRL-C 200%, Tracil dye from Ciba.

Stage 3

The threads to be coloured have been dipped in the colouring bath prepared in stage 2. After dipping the thread, the temperature of the colouring bath is maintained during 15 minutes at a temperature of 50° C. After said first colouring step, the temperature of the bath is increased to about 130° C. The bath is closed, so that said colouring step is carried out under pressure (pressure higher than about 2 10⁵ Pa) during 20 to 40 minutes, especially about 30 minutes. It has been observed that the softness of the coloured fibres or threads was improved by such a heat treatment. Thereafter the colouring bath is cooled down to 75° C. and maintained at said temperature for 15 minutes.

Stage 4

The threads present in the bath are submitted to a reduction cleaning for 10 minutes, said cleaning being carried out by adding 2.75 g sodium hydroxide and 2.75 g sodium hydrosulfite per litre of bath. Said reduction cleaning is carried out at a temperature of 75° C.

Stage 5

The bath is cooled to 50° C. and is neutralized with addition of formic acid at a rate of 0.25 g/l.

Stage 6

The supports with the dyed threads are removed from the bath, rinsed and dried. The dried threads are rewound on carton cones.

When carrying the colouring tests, it appears that the colouring was excellent when the polystyrene content in the mixture was higher than 10%, especially between 13% and 17%. It appears also that with such a Polystyrene content, possible variations of 10% of a parameter (such as duration, pH, concentration of additives) in the colouring methods were not affecting the quality of the end coloured product.

It was also observed that the dyed fibres and threads had an improved soft or touch with respect to the non dyed fibres and threads, as well as with respect to the PP fibres or threads. The softness of the dyed fibres and threads was similar to that of acrylic fibres.

Printing

The printing of a support made from fibres or threads or tuft or felt of PP/PS, such as a carpet (tufted carpet, woven carpet, non woven carpet), was made with a Chromo Jet (Zimmer) machine. According to a further embodiment, the fibres or threads was containing a dye, such as a powder dye, so that the fibres or threads have a basic colour. The printing of such fibres or threads is then equivalent to an overprinting.

The printing composition was prepared as follows:

A disperse dye was mixed with water, with an anionic thickener (10 to 30 g/l), a nonionic levelling agent (1 to 3 g/l) and citric acid (2 to 3 g/l, so as to adjust the pH up to about 4). The content of disperse dye in the composition is from 2 to 4 g/l.

Examples of possible disperse dyes suitable for printing are Tracil Yellow CR, Tracil Red CB, Tracil Blue C3B (Ciba Geigy)

The composition applied on the support was heated at a temperature of 95 to 98° C. The printing was fixed by keeping the temperature at 95-98° C. for about 15 minutes.

In another printing process, the composition applied on the support was heated at a temperature of about 100° C., while the printing was fixed by keeping the temperature at about 120° C. for about 15 minutes. Such a heat treatment at about 120° C. (fixation step of the printing) resulted in a better softness texture and a very good fixation of the printing.

It has been observed that a carpet (tufted carpet, woven carpet, non woven carpet) made from fibres or threads dyed according to the first example of dying method was able to be overprinted according to the printing process.

Tested Yarns

Various yarns have been tested, before and after printing according to the method of the invention.

| | Reference | 13% PS | 15% PS | 20% PS |
|---|---|---|---|---|
| yarn | Nylon | 87% PP | 85% PP | 80% PP |
| Yarn | | | | |
| Count* | | | | |
| average | 1152.6 | 1052 | 1254 | 1251.3 |
| C.V % | 1.3 | 0.6 | 0.3 | 0.2 |
| Breaking | | | | |
| Strength | | | | |
| Tensorapid** | | | | |
| Breaking | | | | |
| Load (kg) | 3.14 | 3.08 | 2.63 | 2.77 |
| C.V. (%) | 3.0 | 3.1 | 5.5 | 5.3 |
| RKm | 2.72 | 2.92 | 2.1 | 2.21 |
| breaking | | | | |
| tenacity | | | | |
| (g/den) | | | | |
| Breaking | | | | |
| elongation % | 28.5 | 22.7 | 23.4 | 23.2 |
| C.V. % | 4.1 | 8.2 | 8.7 | 8.9 |
| Coefficient | 0.33 | 0.33 | 0.28 | 0.27 |
| of friction*** | | | | |

PP and PS are the weight content respectively in Polypropylene and Polystyrene
*measured according to the Norm ASTM D 1907-01, average value expressed in Denier.
C.V. %*: coefficient of variation of the average yarn count, expressed in %
**measured according to the AST D 2256-02 Norm
C.V. %: coefficient of variation expressed in %
***measured according to Norm B.S. 3/49

As it can be seen from the previous table, the yarn containing 13% PS and having an average yarn count of about 1052 denier has properties very similar to the Nylon reference. When using 15 to 20% PS in the blend, there is substantially no difference with respect to the properties (yarn count, breaking strength and coefficient of friction).

| yarn | Reference PP | 10% PS + 90% PP |
|---|---|---|
| Yarn Count* | | |
| average | 2589.6 | 2485.9 |
| C.V % | 0.4 | 0.2 |
| Breaking | | |
| Strength | | |
| Tensorapid** | | |
| Breaking | | |
| Load (kg) | 5.67 | 5.85 |
| C.V. (%) | 1.3 | 1.6 |
| RKm | 2.19 | 2.35 |
| breaking | | |
| tenacity | | |
| (g/den) | | |
| Breaking | | |
| elongation % | 31.4 | 25.1 |
| C.V. % | 2.2 | 4.3 |
| Coefficient | 0.26 | 0.29 |
| of friction*** | | |

PP and PS are the weight content respectively in Polypropylene and Polystyrene
*measured according to the Norm ASTM D 1907-01, average value expressed in Denier.
C.V. %*: coefficient of variation of the average yarn count, expressed in %
**measured according to the AST D 2256-02 Norm
C.V. %: coefficient of variation expressed in %
***measured according to Norm B.S. 3/49

This table shows that yarns with a 2600 denier containing already about 10% PS have properties similar to the PP yarns with a weight of 2600 denier.

The yarns with a weight of 2600 denier were used for producing a woven carpet. The so prepared carpets were pressed for 24 hours with a constant load of 2.9 kg/m² and the height of the carpet pile was measured in function of the time after removal of the pressure. The initial pile height of the carpet was 10 mm, while after the compression step said height was about 5 mm. It appears from said test that the PS-PP yarns of the invention were more suitable for recovering their initial height, i.e. their height before being pressed. It appears that with the PS-PP yarns of the invention 60% of the height could be recovered in two minutes, while with the PP yarns, more than 2 hours were necessary for recovering 60% of the height. 24 hours after the removal of the pressure, 80% of the height was recovered with the PP-PS yarns of the invention, while more than 55 hours were necessary for the PP yarns. In less than 48 hours, the height recovery was about 100%, i.e. in less than 48 hours, the initial aspect of carpet was recovered.

The carpet prepared by the PP-PS yarns of the invention had thus better performance against static loading.

Similar tests have been made on various product made from the same yarns. Said products are tufted 1/10 bouclé with a pile height of 3 mm (compressed to about a zero pile height), tuft 1/10 velours with a pile height of 3 mm (compressed to about a zero pile height). In said tests, in less than 48 hours, the initial pile height was recovered.

Examples of Supports

Various supports have been prepared, namely:

Carpets, tufted carpets, woven carpets, non woven carpets: soft, stain resistance, easy to wash or clean, dust resistance (dust can easily be removed by suction).

Garments: soft, stain resistance, easy to wash , possibility to replaced sewing points or lines by melting, gluing, velours, boucled tufted, etc.

Films or layers: film can be made in PP/PS in various quality and thickness by the known techniques, such as extrusion/blowing, etc. The films can be used for various purposes, such as bags, packaging film, sealing film, food sealing films, unidirectional film, etc. The film is easily printable and has good barrier property (oxygen barrier property), with low release of inner compounds. The film can be unidirectional, bi directional, embossed, can be laminated with one or more further layers, such as polyethylene layer, etc. the film or layer can be reinforced with other fibres, such as glass fibres, carbon fibres, etc. The films or layers can be attached to a support, such as a flexible support, a latex layer, a foam layer, etc. but can also be overcoated with one or more protection layers.

Bank notes

Foam support: with open or closed cells

Moulded supports, such as for the automobile, etc.

Bags

Bottles, food containers,

Web, fibres web

Diapers

Apparel: Activewear and sportswear; socks; thermal underwear; lining fabrics

Automotive: Interior fabrics used in or on kick panel, package shelf, seat construction, truck liners, load decks, etc.

Home Furnishings: Indoor and outdoor carpets; carpet backing; upholstery and wall coverings; furniture and bedding construction fabrics

Industrial: Carpets; disposable, durable nonwoven fabrics; ropes; filter fabrics; bagging; geotextiles

It has been observed that when submitting a coloured fabric of the invention, especially a woven fabric to a calendaring step at a temperature comprised between 110 and 130° C., it was possible to further increase the softness texture of the fabrics.

Examples of Particles PP/PS

Commercially polypropylene has been mixed homogeneously with polystyrene and with an UV stabiliser. The mixture is fed into an extrusion facility and processed into continuous threads, which are cut in granules or flakes or which are shaped in beads. The weight average particle size of the particles was controlled respectively to 1 mm, 2 mm, 3 mm and 5 mm. The particle size distribution can also be multi modal, such as bi-modal, i.e. having the form of a mixture of two different type of particles, such as a first fraction of particles having an average particle size lower than 2 mm and a second fraction of particles having an average particle size greater than 3 mm.

The polypropylene used has a Melt Flow rate (MFR ASTM—1238 L) lower than 80 g/10 minutes, preferably lower than 30 g/10 minutes. While the density (ASTM—D1505) of the PP can vary from 0.90 and 0.91 (g/cm³). The melting point of said polypropylene was about 165° C. (DSC). Other properties of the polypropylene are elongation of about 30 to 40%, tenacity of 3 to 5 g/denier, linear skein shrinkage (ASTM D3218) of about 3 to 4.5%, a softening point from about 150° C. and 220° C. (ASTM D-1525). The Polypropylene is advantageously amorphous. The used polypropylene has advantageously a Tg of about 0° C.

The following PP have been used in the preparation of PP/PS particles.

The following mixtures have been used for preparing the particles suitable for preparing the threads to be coloured. In said mixtures, the UV stabilizer used was the product Tanvin®.

| | | | UV |
|---|---|---|---|
| | PP | PS | stabilizer |
| Mixture | % by weight | % by weight | % by weight |
| 1 | PP1 90% | PS atactic 9% | 1% |
| 2 | PP2 85% | PS atactic 14.5% | 0.5% |
| 3 | PP2 87% | PS syndiotactic | 0.5% |
| | | 12.5% | |
| 4 | PP3 92.5% | PS atactic 7% | 0.5% |
| 5 | PP3 89.5% | PS atactic 10% | 0.5% |
| 6 | PP3 86.5% | PS atactic 13% | 0.5% |
| 7 | PP3 89.5% | PS syndiotactic | 0.5% |
| | | 10% | |
| 8 | PP3 86.5% | PS syndiotactic | 0.5% |
| | | 13% | |
| 9 | PP4 90% | PS atactic 9% | 1% |
| 10 | PP4 87% | PS atactic 12.5% | 0.5% |
| 11 | PP3 50% + PP2 | PS atactic 12.5% | 0.5% |
| | 37% | | |
| 12 | PP3 87% | PS atactic 6% + PS | 0.5% |
| | | syndiotactic | |
| | | 6.5% | |
| 13 | PP3 87% | PS atactic 10% + PS | 0.5% |
| | | syndiotactic | |
| | | 2.5% | |
| 14 | PP3 87% | PS atactic 2.5% + PS | |
| | | syndiotactic | |
| | | 10% | |
| 15 | PP1 45% + PP2 | PS atactic 9.5% | 0.5% |
| | 45% | | |

Said mixture have been repeated except that citric acid was added so that the citric acid content of the particles was from 0.1 to 0.2% by weight.

What I claim is:

1. Colouring process of Polypropylene/polystyrene support with a polystyrene/polypropylene weight ratio comprised between 1:10 and 1:5, in which the polystyrene is selected from the group consisting of syndiotactic polystyrene, atatic polystyrene and mixtures thereof, in which the support is submitted to a colouring step by contacting the support with an aqueous dying composition having a pH comprised between 3 and 5, said aqueous dying composition comprising from 0.1 to 4% by weight disperse dye, organic acid with 1 to 6 carbon atoms, and at least a surfactant, whereby said colouring step is at least operated partly at a temperature higher than 90° C.

2. The colouring process of claim 1, in which the polypropylene is an amorphous polypropylene.

3. The process of claim 1, in which the polypropylene is an amorphous polypropylene having a Tg of about 0° C.

4. The process of claim 1, in which the support is selected from the group consisting of fibres, threads, layers, films and combinations thereof.

5. The colouring process of claim 1, in which the organic acid with 1 to 6 carbon atoms is present in the aqueous dying composition, so that the pH of said composition is about 4.

6. The colouring process of claim 1, in which the pH of the dying composition is maintained at a substantially constant pH by addition of acid during at least a time portion of the colouring step.

7. The colouring process of claim 1, in which the colouring step is carried out for a determined total time, and in which the pH of the dying composition is maintained at a substantially constant pH by addition of acid during a time portion corresponding to at least 50% of the total time of the colouring step.

8. The colouring process of claim 1, in which at least citric acid is used as organic acid.

9. The colouring process of claim 1, in which the organic acid is citric acid.

10. The colouring process of claim 1, in which the organic acid content of the composition is comprised between 1 and 10 g/l.

11. The colouring process of claim 1, in which the organic acid content of the composition is comprised between 1 and 5 g/l.

12. The colouring process of claim 1, in which the support comprises more than 90% by weight polypropylene and polystyrene.

13. The colouring process of claim 1, in which the support comprises more than 95% by weight polypropylene and polystyrene.

14. The colouring process of claim 1, in which the support comprises more than 99% by weight polypropylene and polystyrene.

15. The colouring process of claim 1, in which the colouring step is at least operated partly at a temperature higher than 130° C. and at a pressure higher than 10⁵ Pa.

16. The colouring process of claim 1, in which the colouring step is at least operated partly at a temperature higher than 130° C. and at a pressure higher than 10⁵ Pa for at least 5 minutes.

17. The colouring process of claim 1, in which the colouring step is at least operated partly at a temperature higher than 130° C. and at a pressure higher than 10⁵ Pa for at least 10 minutes.

18. The colouring process of claim 1, in which the colouring step is at least operated partly at a temperature higher than 130° C. and at a pressure higher than 10⁵ Pa for at least 15 minutes.

19. The colouring process of claim 1, in which the colouring step is at least operated partly at a temperature comprised between 140° C. and 150° C. and at a pressure higher than 10⁵ Pa.

20. The colouring process of claim 1, in which the colouring step is at least operated partly at a temperature higher than 130° C. and at a pressure comprised between 1.5 10⁵ Pa and 10 10⁵ Pa.

21. The colouring process of claim 1, in which after the colouring step, the support is washed and dried.

22. The colouring process of claim 1, in which the support is threads consisting of fibres.

23. The colouring process of claim 1, which is a printing process, said process comprising a fixing step following the colouring step, said fixing step being advantageously carried out at a temperature greater than 110° C. for at least 10 minutes.

24. Coloured polypropylene/polystyrene support with a polystyrene/polypropylene weight ratio comprised between 1:10 and 1:5, in which the polystyrene is selected from the group consisting of syndiotactic polystyrene, atatic polystyrene and mixtures thereof, said support having been submitted to a colouring step by contacting the support with an aqueous dying composition having a pH comprised between 3 and 5, said aqueous dying composition comprising from 0.1 to 4% by weight disperse dye, organic acid with 1 to 6 carbon atoms, and at least a surfactant, whereby said colouring step is at least operated partly at a temperature higher than 90° C.

25. The coloured support of claim 24, in which the polypropylene is an amorphous polypropylene.

26. The coloured support of claim 24, in which the polypropylene is an amorphous polypropylene having a Tg of about 0° C.

27. The coloured support of claim 24, in which the support is selected from the group consisting of fibres, threads, layers, films and combinations thereof.

28. The coloured support of claim 24, which is selected from the group consisting of woven fabrics, non woven fabrics, carpets, garments, filter media, furniture upholstery, synthetic paper, films, bags, laminated products and combinations thereof.

29. The coloured support of claim 24 comprising a matrix made essentially of Polypropylene and Polystyrene, whereby the weight ratio polystyrene/polypropylene is comprised between 12:88 and 17:83.

30. The coloured support of claim 24 comprising a matrix made essentially of Polypropylene and Polystyrene, whereby the weight ratio polystyrene/polypropylene is about 15:85.

31. The coloured support of claim 24 comprising from 0.05% and 1% by weight of at least an organic acid with 1 to 6 carbon atoms.

32. The coloured support of claim 24 comprising from 0.05% and 1% by weight of citric acid.

33. The coloured support of claim 24 comprising more than 90% by weight polypropylene and polystyrene.

34. The coloured support of claim 24 comprising more than 95% by weight polypropylene and polystyrene.

35. The coloured support of claim 24 comprising more than 99% by weight polypropylene and polystyrene.

36. The coloured support of claim 24 in the form of yarns having a breaking load measured according to the norm ASTM D 2256-02 comprised between 3 and 3.15, a breaking tenacity RKm measured according to the norm ASTM D 2256-02 comprised between 2.5 and 3 g/den, and a coefficient of friction measured according to the norm B.S. 3/49 comprised between 0.3 and 0.35.

37. The coloured yarns of claim 36, which has recovery properties such that a woven carpet made of yarns with a weight comprised between 2000 and 3000 denier and with a pileheight of 10 mm compressed to a height of 5 mm by using a constant load of 2.9 kg/m² recovers more than 60% of its pileheight after 2 minutes.

38. The coloured support of claim 24 in the form of yarns having a breaking load measured according to the norm ASTM D 2256-02 comprised between 3 and 3.15, a breaking tenacity RKm measured according to the norm ASTM D 2256-02 comprised between 2.5 and 3 g/den, and a coefficient of friction measured according to the norm B.S. 3/49 comprised between 0.3 and 0.35, whereby said yarns have recovery properties such that a woven carpet made of yarns with a weight comprised between 2000 and 3000 denier and with a pileheight of 10 mm compressed to a height of 5 mm by using a constant load of 2.9 kg/m² recovers more than 80% of its pileheight after 24 hours.

39. The coloured support of claim 24 in the form of yarns having a breaking load measured according to the norm ASTM D 2256-02 comprised between 3 and 3.15, a breaking tenacity RKm measured according to the norm ASTM D 2256-02 comprised between 2.5 and 3 g/den, and a coefficient of friction measured according to the norm B.S. 3/49 comprised between 0.3 and 0.35, whereby said yarns have recovery properties such that a woven carpet made of yarns with a weight comprised between 2000 and 3000 denier and with a pileheight of 10 mm compressed to a height of 5 mm by using a constant load of 2.9 kg/m² recovers about 100% of its pileheight in less than 48 hours.

40. A coloured product selected from the group consisting of carpets and tufted product, whereby said product comprises coloured polypropylene/polystyrene yarns with a polystyrene/polypropylene weight ratio comprised between 1:10 and 1:5, in which the polystyrene is selected from the group consisting of syndiotactic polystyrene, atatic polystyrene and mixtures thereof, said yarns having been submitted to a colouring step by contacting the support with an aqueous dying composition having a pH comprised between 3 and 5, said aqueous dying composition comprising from 0.1 to 4% by weight disperse dye, organic acid with 1 to 6 carbon atoms, and at least a surfactant, whereby said colouring step is at least operated partly at a temperature higher than 90° C.

41. The coloured product of claim 40, in which the polypropylene of said coloured PP/PS yarns is an amorphous polypropylene.

42. The coloured product of claim 40, in which the polypropylene of said coloured PP/PS yarns is an amorphous polypropylene having a Tg of about 0° C.

43. The coloured product of claim 40, in which said coloured PP/PS yarns comprises a matrix made essentially of Polypropylene and Polystyrene, whereby the weight ratio polystyrene/polypropylene is comprised between 12:88 and 17:83.

44. The coloured product of claim 40, in which said coloured PP/PS yarns comprises a matrix made essentially of Polypropylene and Polystyrene, whereby the weight ratio polystyrene/polypropylene is about 15:85.

45. The coloured product of claim 40, in which said coloured PP/PS yarns comprises from 0.05% and 1% by weight of at least an organic acid with 1 to 6 carbon atoms.

46. The coloured product of claim 40, in which said coloured PP/PS yarns comprises from 0.05% and 1% by weight of citric acid.

47. The coloured product of claim 40, in which said coloured PP/PS yarns comprises more than 90% by weight polypropylene and polystyrene.

48. The coloured product of claim 40, in which said coloured PP/PS yarns comprises more than 95% by weight polypropylene and polystyrene.

49. The coloured product of claim 40, in which said coloured PP/PS yarns comprises more than 99% by weight polypropylene and polystyrene.

50. The coloured product of claim 40, in which said coloured PP/PS yarns have a breaking load measured according to the norm ASTM D 2256-02 comprised between 3 and 3.15, a breaking tenacity RKm measured according to the norm ASTM D 2256-02 comprised between 2.5 and 3 g/den, and a coefficient of friction measured according to the norm B.S. 3/49 comprised between 0.3 and 0.35.

51. The coloured product of claim 50, which has recovery properties such that a product made of said coloured PP/PS yarns with a weight comprised between 2000 and 3000 denier and with a pileheight of 10 mm compressed to a height of 5 mm by using a constant load of 2.9 kg/m² recovers more than 60% of its pileheight after 2 minutes.

52. The coloured product of claim 40, in which said coloured PP/PS yarns have a breaking load measured according to the norm ASTM D 2256-02 comprised between 3 and 3.15, a breaking tenacity RKm measured according to the norm ASTM D 2256-02 comprised between 2.5 and 3 g/den, and a coefficient of friction measured according to the norm B.S. 3/49 comprised between 0.3 and 0.35, whereby said coloured product has recovery properties such that the product made of said coloured PP/PS yarns with a weight comprised between 2000 and 3000 denier and with a pileheight of 10 mm compressed to a height of 5 mm by using a constant load of 2.9 kg/m² recovers more than 80% of its pileheight after 24 hours.

53. The coloured product of claim 40, in which said coloured PP/PS yarns have a breaking load measured according to the norm ASTM D 2256-02 comprised between 3 and 3.15, a breaking tenacity RKm measured according to the norm ASTM D 2256-02 comprised between 2.5 and 3 g/den, and a coefficient of friction measured according to the norm B.S. 3/49 comprised between 0.3 and 0.35, whereby said coloured product has recovery properties such that the product made of said coloured PP/PS yarns with a weight comprised between 2000 and 3000 denier and with a pileheight of 10 mm compressed to a height of 5 mm by using a constant load of 2.9 kg/m² recovers about 100% of its pileheight in less than 48 hours.

54. Polypropylene/polystyrene particles intended to be used for the preparation of a support suitable to be processed in the process of claim 1, said particles comprising a blend of polystyrene and polypropylene.

55. The particles of claim 54 having a weight average particle size comprised between 10 μm and 10 mm.

56. The particles of claim 54 having a weight average particle size comprised between 100 μm and 5 mm.

57. The particles of claim 54 consisting of a substantially homogeneous matrix.

58. The particles of claim 54, in which the polypropylene is an amorphous polypropylene.

59. The particles of claim 54, in which the polypropylene is an amorphous polypropylene having a Tg of about 0° C.

60. The particles of claim 54 comprising a matrix made essentially of Polypropylene and Polystyrene, whereby the weight ratio polystyrene/polypropylene is comprised between 12:88 and 17:83.

61. The particles of claim 54 comprising a matrix made essentially of Polypropylene and Polystyrene, whereby the weight ratio polystyrene/polypropylene is about 15:85.

62. The particles of claim 54 comprising from 0.05% and 1% by weight of at least an organic acid with 1 to 6 carbon atoms.

63. The particles of claim 54 comprising from 0.05% and 1% by weight of citric acid.

64. The particles of claim 54 comprising more than 90% by weight polypropylene and polystyrene.

65. The particles of claim 54 comprising more than 95% by weight polypropylene and polystyrene.

66. The particles of claim 54 comprising more than 99% by weight polypropylene and polystyrene.
